(19) United States
(12) Patent Application Publication
(10) Pub. No.: US 2013/0088484 A1
(43) Pub. Date: Apr. 11, 2013

(54) DISPLAYING CONTENT ITEMS RELATED TO A SOCIAL NETWORK GROUP

(71) Applicants: Gregory Matthew MARRA, San Francisco, CA (US); Benjamin David Eidelson, Palo Alto, CA (US)

(72) Inventors: Gregory Matthew MARRA, San Francisco, CA (US); Benjamin David Eidelson, Palo Alto, CA (US)

(73) Assignee: GOOGLE INC., Mountain View, CA (US)

(21) Appl. No.: 13/267,857

(22) Filed: Oct. 6, 2011

(51) Int. Cl. G06T 1/00

(52) U.S. Cl. 345/418

(57) ABSTRACT

Systems and methods for presenting social content are provided. In some aspects, a method includes receiving a new content item. The new content item is not associated with a social network group comprising a set of subject members and a set of viewing members. The method also includes determining that the new content item is related to the social network group. The method also includes storing the new content item in association with the social network group. The method also includes providing for display a representation of the new content item and an indication of the social network group.

### FIELD

The subject technology generally relates to social networking software and, in particular, relates to a system and method for displaying content items related to a social network group.

### BACKGROUND

Social networking services are designed, in part, to store and provide information about the social contacts of a user. Oftentimes, social networking services include social network groups. Social network groups may be asymmetric or symmetric. Asymmetric social groups, for example, social circles, may include a single viewing member who created the social circle and one or more subject members, about whom content is stored. Symmetric social network groups may include a set of viewing members that is equivalent to the set of subject members. One purpose of social network groups is to store interesting data about the interactions between members in the groups. For example, a family group might find the fact that two adult brothers had dinner together interesting. However, one drawback of social network groups is that the subject members of the group typically post content about their activities that might be interesting to the viewing members of the group outside the social network group. Thus, the social network group may be missing content that is stored within the social networking service and relevant or interesting to the viewing members of the group. As the foregoing illustrates, a technique to gather and display content items that are relevant or interesting to the social network group from outside the social network group may be desirable.

### SUMMARY

The disclosed subject matter relates to a method for presenting social content. The method includes receiving a new content item. The new content item is not associated with a social network group including a set of subject members and a set of viewing members. The method also includes determining that the new content item is related to the social network group. The method also includes storing the new content item in association with the social network group. The method also includes providing for display a representation of the new content item and an indication of the social network group.

The disclosed subject matter further relates to a non-transitory computer-readable medium. The computer-readable medium includes instructions that, when executed by a computer, cause the computer to implement a method for presenting social content. The instructions include code for receiving a new content item. The new content item is not associated with a social network group including a set of subject members and a set of viewing members. The instructions also include code for determining that the new content item is related to the social network group. The instructions also include code for storing the new content item in association with the social network group. The instructions also include code for transmitting for display a representation of the new content item to a feed associated with the social network group.

The disclosed subject matter further relates to a system. The system includes one or more processors. The system also includes a memory that includes instructions that, when executed by the one or more processors, cause the one or more processors to implement a method for presenting social content. The instructions include code for receiving a new content item. The new content item is not associated with a social network group. The instructions also include code for determining that the new content item is related to the social network group. The instructions also include code for storing the new content item in association with the social network group. The instructions also include code for providing for display a representation of the new content item and an indication of the social network group to a feed associated with the social network group. The indication of the social network group includes a name associated with the social network group or an image associated with the social network group

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several aspects of the disclosed subject matter are set forth in the following figures.

FIG. 1 illustrates an example of a computer system configured to implement displaying content items related to a social network group.

FIG. 2 illustrates an example of the database of FIG. 1 in more detail.

FIG. 3 illustrates an example of data that may be stored in the database memory of FIG. 2 in more detail.

FIG. 4 illustrates an example of the content presentation server of FIG. 1 in more detail.

FIG. 5 illustrates an example process by which a content item related to a social network group may be displayed.

FIG. 6 illustrates an example process by which a content item related to a social network group may be created from two or more content items.

FIG. 7 illustrates an example web browser window configured to display content items related to a social network group.

FIG. 8 illustrates an example web browser window configured to display content items related to an individual profile.

FIG. 9 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is related to approaches for presenting social content. One technique involves receiving a new content item, such as an image, a video, a text, audio or video chat room interface, or the content of a chat or messaging session. The new content item may not be associated with a social network group that includes a set of subject members and a set of viewing members. The technique also involves determining that the new content item is related to the social network group. The new content item may be related to the social network group if the new content item is associated with at least two subject members of the social network group, for example, if two subject members are mentioned in the new content item or indicated a preference for the new content item. The technique also involves storing the new content item in association with the social network group. The technique also involves providing for display a representation of the new content item and an indication of the social network group in response to a request to view the social network group by a viewing member.

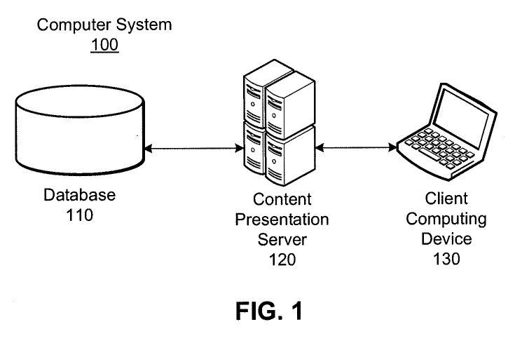

FIG. 1 illustrates an example of a computer system 100 configured to implement displaying content items related to a social network group.

As shown, the computer system 100 includes a database 110, a content presentation server 120, and a client computing device 130. The database 110, content presentation server 120, and client computing device 130 may be configured to communicate with one another via a network, such as the Internet, an intranet or a cellular network or via a wired or wireless connection.

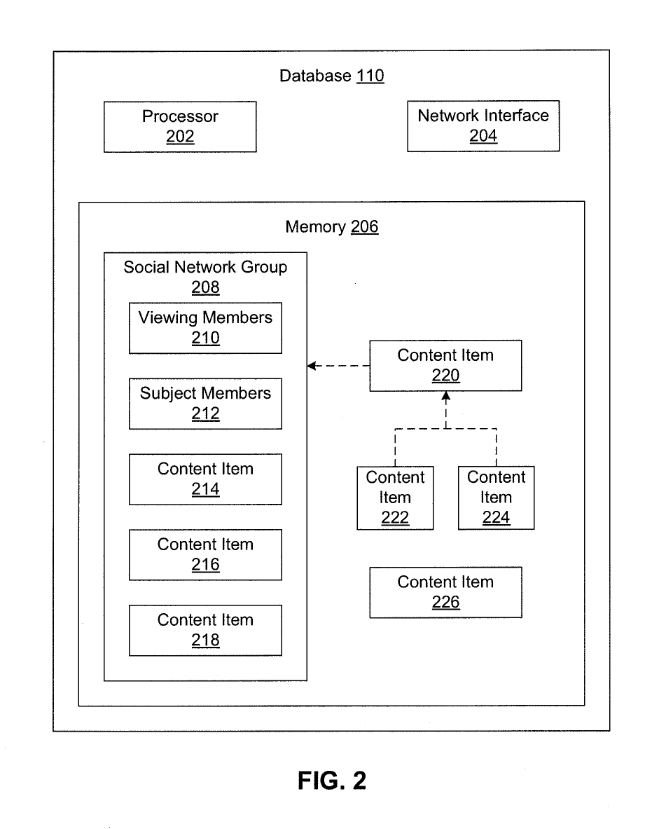

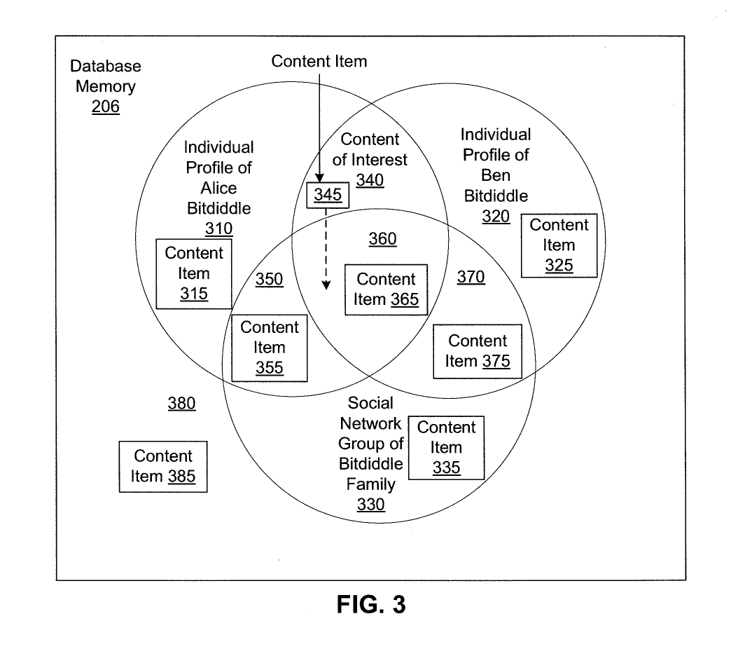

The database 110 is configured to store content or data to be presented by the content presentation server 120. The database 110 is described in more detail in conjunction with FIGS. 2-3, below. While one database 110 is illustrated here, persons skilled in the art will recognize that the techniques disclosed herein may be implemented with multiple databases 110.

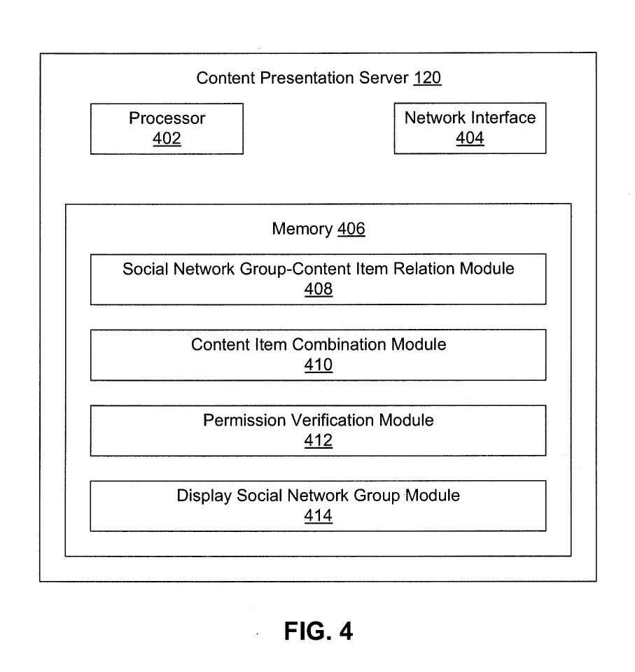

The content presentation server 120 is configured to receive content from the database 110 and to provide or transmit for display the content that is received from the database 110 to the client computing device 130. The content presentation server 120 is described in more detail in conjunction with FIG. 4, below. While one content presentation server 120 is illustrated here, persons skilled in the art will recognize that the techniques disclosed herein may be implemented with multiple content presentation servers 120. Furthermore, the content presentation server 120 and the database 110 may be implemented in the same machine or in different machines.

The client computing device 130 may be any computing device capable of displaying content, such as photographs, videos, articles or comments, to a user. The client computing device 130 may be a laptop computer, a desktop computer, a mobile phone, a personal digital assistant (PDA), a tablet computer, a netbook, a physical machine or a virtual machine. Persons skilled in the art will recognize other devices that could implement the functionalities of the client computing device 130. The client computing device 130 may include one or more of a keyboard, a mouse, a touch screen, and a display to allow the user to interact with the content. Furthermore, while only one client computing device 130 is illustrated here, persons skilled in the art will recognize that the techniques disclosed herein may be implemented with multiple client computing devices 130.

FIG. 2 illustrates an example of the database 110 of FIG. 1 in more detail.

As shown, the database 110 includes a processor 202, a network interface 204, and a memory 206. The processor 202 is configured to execute computer instructions that are stored in a computer-readable medium, such as the memory 206. For example, the processor 202 may be a central processing unit (CPU). The network interface 204 is configured to allow the database 110 to transmit and receive data in the network. The network interface 204 may include one or more network interface cards (NICs). The memory 206 stores data and instructions. As illustrated, the memory 206 stores information associated with one or more social network groups 208 and a plurality of content items 220, 222, 224, and 226 external to the social network group.

The information associated with the social network group 208 may include an identification of one or more viewing members 210 and an identification of one or more subject members 212. The information associated with the social network group 208 may concern, for example, a symmetric social network group, an asymmetric social network group, an individual profile or a combination of two or more individual profiles. The viewing members 210 may be identical to the subject members 212. Alternatively, the set of viewing members 210 may include the set of subject members 212, meaning that all subject members 212 are also viewing members 210 but some viewing members 210 may not be subject members 212. In one example, the set of viewing members 210 may be different from the set of subject members 212 to the degree that at least one subject member 212 is not a viewing member 210. For example, a social circle may have multiple subject members 212 and a single viewing member 210 who created the social circle. An individual profile may have a single subject member 212 who created the individual profile and multiple viewing members 210 who are acquaintances of the subject member 212. Symmetric social network groups, for example a family group or a university alumni group, may have identical viewing members 210 and subject members 212.

Social circles are one example of asymmetric social network groups. As used herein, “social circles” are categories to which a user can assign his/her social networking contacts and better control the distribution and visibility of social networking messages. A social circle is a social network group that may have a set of subject members 212 that includes these contacts. In accordance with the subject disclosure, a social circle is provided as a data set defining, in the set of subject members 212, a collection of contacts that are associated with one another. A social circle can be described from the perspective of an individual viewing member 212 that is the center of a particular collection of socially interconnected people, or from the aggregate perspective of a collection of socially interconnected people. A social circle can have narrowly defined boundaries, all of the members of the social circle may be familiar with one another, and permission may be required for a member to join a social circle. A user of an electronic device may define a social circle, and the social circle, as a data set defining a collection of contacts, may reflect a real-life social circle of the user. A social circle may have a single viewing member 210 and multiple subject members 212.

For example, a user of an electronic device may have different groups of friends, coworkers and family, and there may be some overlap among those groups (e.g., a coworker who is also considered to be a friend, a family member who is also a coworker). Through the creation and use of social circles, the user can organize and categorize social networking contacts into various different groupings. Other examples of social network groups may include a group of users in a computer or mobile phone-based chat session, for example, a short message service (SMS) chat session or an instant messaging (IM) chat session, an individual profile in a social networking service, or a combination of two or more individual profiles in the social networking service.

The information associated with the social network group 208 may also include content items 214, 216, and 218 that are associated with the social network group and stored within the information associated with the social network group 208. Each content item 212, 216 or 218 may include one or more photographs, videos, geographic check-ins, articles, reviews of geographic points of interest, text, audio or video chat room interfaces, status updates or calendar events. Content items 214, 216, and 218 may be added to the information associated with the social network group 208 by one or more of the subject members 212.

Additional content items 220, 222, 224, and 226 may be stored outside the information associated with the social network group 208. The additional content items 220, 222, 224, and 226 may not be associated with the social network group.

Some content items may be associated with a geographic location. The geographic location may correspond to a geographic point of interest, such as a business or a park, situated at the geographic location. The point of interest may be derived from the geographic location or vice versa. The geographic location may be included in the content item. For example, photographic and video content items taken by some cameras may include a geographic code that corresponds to a location. Alternatively, the geographic location may be derived based on the content item. For example, if the content item is a review of a restaurant, the corresponding geographic location may be the address of the restaurant. Some content items, for example, chat room interfaces or photographs lacking any geographic indication, may lack a location.

The content items may be provided to database 110 by users of the social networking service. Alternatively, the content items may be gathered from sources external to the database 110 using, for example, a web crawler. However, users of the social networking service may opt out of having data about the user gathered from sources external to the social networking service being brought into the social networking service. In one implementation, the user may indicate that he/she wishes to opt out of having such data brought into the social networking service by modifying his/her account settings with the social networking service.

FIG. 3 illustrates an example of data that may be stored in the database memory 206 of FIG. 2 in more detail.

As shown, the database memory 206 includes an “individual profile of Alice Bitdiddle” 310, an “individual profile of Ben Bitdiddle” 320, and a “social network group of the Bitdiddle family” 330, all of which are associated with a social networking service. Alice Bitdiddle and Ben Bitdiddle are the only subject members and the only viewing members of the Bitdiddle family social network group 330. In addition, the user Alice Bitdiddle has permission to view one or more content items 325 in the individual profile of Ben Bitdiddle 320, and the user Ben Bitdiddle has permission to view one or more content items 315 in the individual profile of Alice Bitdiddle 310. The individual profiles of Alice Bitdiddle 310 and Ben Bitdiddle 320, as well as the social network group of the Bitdiddle family 330 include content items, for example content items 315, 325, and 335. Some contents items 315 within Alice Bitdiddle's profile 310 are associated with the individual profile of Alice Bitdiddle 310 only. Some content items 325 within Ben Bitdiddle's profile 320 are associated with the individual profile of Ben Bitdiddle 320 only. Some content items 335 within the Bitdiddle family social network group 330 are associated with the social network group of the Bitdiddle family 330 only.

Content items 345 within region 340 are associated with the individual profiles of both Alice Bitdiddle 310 and Ben Bitdiddle 320. As region 340 includes information about both Alice Bitdiddle and Ben Bitdiddle, content items 345 in region 340 are interesting for the Bitdiddle family social network group 330. Thus, content items 345 in region 340 might be automatically brought into the Bitdiddle family social network group 330. However, it should be noted that either Alice Bitdiddle or Ben Bitdiddle may opt out of having their content items 345 automatically brought into the Bitdiddle family social network group 330. The content presentation server 120 may ensure that any other user associated with a content item 345 approves the content item being added to the social network group 330. If a user other than Alice Bitdiddle or Ben Bitdiddle is associated with one or more content items that are to be automatically brought into the Bitdiddle family social network group, the other user may also opt out of having the content items automatically brought into the Bitdiddle family social network group 330.

Content items 365 in region 360 are associated with all of Alice Bitdiddle's profile 310, Ben Bitdiddle's profile 320, and the Bitdiddle family group 330. Content items 355 in region 350 are associated with Alice's profile 310 and the Bitdiddle family profile 330. Content items 375 in region 370 are associated with Ben's profile 320 and the Bitdiddle family profile 330. Content items 385 in region 380 are associated with neither Alice's profile 310, nor Ben's profile 320, nor the Bitdiddle family profile 330.

FIG. 4 illustrates an example of the content presentation server 120 of FIG. 1 in more detail.

As shown, the content presentation server 120 includes a processor 402, a network interface 404, and a memory 406. The processor 402 is configured to execute computer instructions that are stored in a computer-readable medium, such as the memory 406. For example, the processor 402 may be a central processing unit (CPU). The network interface 404 is configured to allow the content presentation server 120 to transmit and receive data in the network. The network interface 404 may include one or more network interface cards (NICs). The memory 406 stores data and instructions. As illustrated, the memory 406 stores a “social network group-content item relation module” 408, a “content item combination module” 410, a “permission verification module” 412, and a “display social network group module” 414.

The “social network group-content item relation module” 408 is configured to determine that a new content item that, initially, is not associated with a social network group could be associated with the social network group and to associate the new content item with the social network group. The social network group-content item relation module 408 may operate by receiving the new content item not associated with the social network group and determining that the new content item is related to the social network group. The new content item may be related to the social network group if the new content item is associated with at least two subject members of the social network group or at least a certain proportion of the subject members of the social network group. The new content item may be associated with one or more subject members, for example, the one or more subject members may have the content item on their individual profiles, the one or more subject members may comment, prefer or otherwise indicate an interest in the new content item, or the one or more subject members may be named in the new content item.

The “content item combination module” 410 is configured to combine two or more related content items, e.g., the two content items 222 and 224, into a single content item, e.g., content item 220. The content item combination module 410 may determine, for example, that a first content item is related to a second content item, and that the combination of the first content item and the second content item is related to a social network group. Content items may be related to one another if the posters of the content items, or others associated with the content items are both subject members of the social network group and the content items are associated with the same geographic point of interest and are proximate in time, thereby indicating that the some of the subject members may have interacted with the same geographic point of interest at the same time. For example, if two subject members of the social network group indicate that they are at the same restaurant at approximately the same time, the content item combination module 410 may conclude that the two members were at the restaurant together and create a new content item indicating this information. The new content item created by the content item combination module 410 may include an indication of each content item from which the new content item was generated. When the content item combination module 410 combines a first content item and a second content item into a new content item, the set of users who have permission to view the new content item may include the intersection of the set of users who have permission to view the first content item and the set of users who have permission to view the second content item. A user of the social networking service may opt out from having new content items generated based on the content items associated with the user.

The “permission verification module” 412 is configured to determine if a user who requests to view a content item has permission to view the content item. The permission verification module 412 may ensure that a set of users who have permission to view a content item that is added to a social network group by either the social network group-content item relation module 408 or the content item combination module 410 includes the viewing members 210 of the social network group. A user posting a new content item may set the permission for other users to view the new content item. The user may allow all users to view the new content item or only members of certain social network groups or social circles to view the new content item.

The “display social network group module” 414 is configured to cause information associated with a social network group to be provided or transmitted for display. The information may be provided or transmitted in response to a request from a requestor to view information associated with the social network group. Alternatively, the information may be stored in a feed associated with the social network group, which my be accessible to a viewing member of the social network group. In responding to a request from the requestor to view the social network group, the display social network group module 414 may determine that the requestor is a viewing member of the social network group and, if so, store or transmit for display a representation of the content items associated with the social network group and an indication of the social network group, such as a name, a title, or an image associated with the social network group. The display social network group module 414 may further determine that the requestor has permission to view the content items that are provided for display.

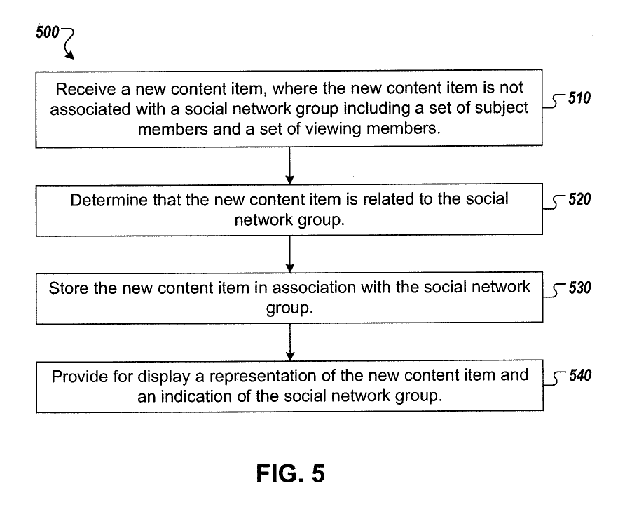

FIG. 5 illustrates a process 500 by which a content item related to a social network group may be displayed.

The process 500 begins at step 510, where the content presentation server 120 receives a new content item that is not associated with a social network group. The social network group may be associated with a set of subject members and a set of viewing members. The new content item may be one or more of an image, a video, an article, a text, audio or video chatroom, a status update or a geographic check-in. The social network group may include a single individual profile, a combination of two or more individual profiles, a social circle or a symmetric social network group.

According to step 520, the content presentation server 120 determines that the new content item 220 is related to the social network group. The new content item may be related to the social network group if the new content item is associated with at least two subject members of the social network group or if the new content item is associated with at least a certain proportion or percentage of the subject members of the social network group, for example, if the content item is associated with at least 20% of the subject members of the social network group.

According to step 530, the content presentation server 120 stores the new content item 220 in association with the social network group. In one example, the content presentation server 120 may determine that all viewing members of the social network group have permission to view the new content item and store the new content item in association with the social network group only if all of the viewing members have permission to view the new content item.

The content presentation server 120 may then receive a request to display information about or content items related to the social network group from a client computing device 130 belonging to a requestor. The content presentation server may determine that the requestor is a viewing member of the social network group and that the requestor has permission to view the new content item.

According to step 540, the content presentation server 120 provides for display a representation of the new content item and an indication of the social network group. The representation of the new content item and the indication of the social network group may then be transmitted to the client computing device 130 and displayed on the client computing device 130. The representation of the new content item may include the entire new content item or a portion or summary of the new content item, for example, a blurb or a thumbnail. The indication of the social network group may include a name of the social network group or an image associated with the social network group. After step 540, the process 500 ends.

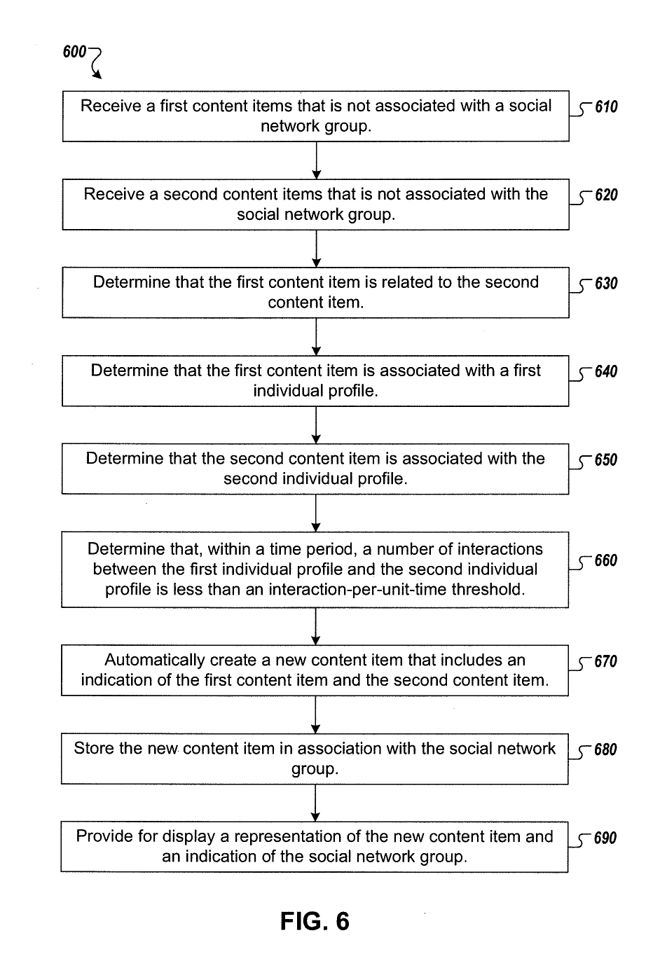

FIG. 6 illustrates a process 600 by which a content item 220 related to a social network group may be created from two or more content items 222 and 224.

The process 600 begins at step 610 where the content presentation server 120 receives a first content item 222 that is not associated with a social network group.

According to step 620, the content presentation server 120 receives a second content item 224 that is not associated with the social network group.

According to step 630, the content presentation server 120 determines if the first content item 222 is related to the second content item 224. The first content item 222 and the second content item 224 may be related if the first content item 222 and the second content item 224 are associated with the same geographic point of interest, for example, if both content items 222 and 224 concern the same business. Also, the first content item 222 and the second content item 224 may be related if the time difference between the times of two content items 222 and 224 is less than a time difference threshold and the first content item 222 and the second content item 224 are related to the same geographic point of interest. The time difference threshold may vary depending on a type of the geographic point of interest. For example, if the geographic point of interest is a bar or a restaurant, then the time difference threshold may be 30 minutes. If the geographic point of interest is a city, then the time difference threshold may be 24 hours.

According to step 640, the content presentation server 120 determines if the first content item 222 is associated with a first individual profile that belongs to a first subject member of the social network group. A content item may be associated with an individual profile if the content item is posted on the individual profile, if the content item mentions the individual associated with the individual profile or if the individual associated with the individual profile indicated a preference for or commented on the content item.

According to step 650, the content presentation server 120 determines if the second content item 224 is associated with a second individual profile that belongs to a second subject member of the social network group. The first subject member may be different from the second subject member.

According to step 660, the content presentation server 120 determines that, within a time period, a number of interactions between the first individual profile and the second individual profile is less than an interaction-per-unit-time threshold. For example, in a social network group of ten subject members, two subject members may be dating and, thus, may interact frequently by posting photographs featuring both of them, checking in at the same restaurants, indicating that they may attend the same calendar events, etc. The two subject members who are dating may interact more than an interaction-per-unit-time threshold. Thus, their interactions may not be interesting to the viewing members of the social network group. On the other hand, two other subject members in a social network group may live in different parts of the country and, therefore, interact rarely. Due to the geographic isolation of the two members, they may have fewer interactions than an interaction-per-unit-time threshold. When these two members interact, for example if one member visits the other member, the interaction may be interesting to the viewing members of the social network group due to its relative infrequency. Alternatively, the content presentation server may consider that an interaction where two or more members who are geographically isolated appear in the same location is interesting regardless of how often the two members interact. Geographically isolated members may often interact via a social networking service but rarely interact in person. Therefore, the in person interactions may be interesting.

According to step 670, the content presentation server 120 automatically creates a new content item 220 that includes an indication of the first content item 222 and the second content item 224. The content presentation server may determine a set of users of the social networking service who have permission to view the new content item 220 based on an intersection of the set of members who have permission to view the first content item 222 and the set of members who have permission to view the second content item 224.

According to step 680, the content presentation server 120 stores the new content item 220 in association with the social network group. The content presentation server 120 may then receive a request to view the social network group from a client computing device 130 of a viewing member 210.

According to step 690, the content presentation server 120 provides for display a representation of the new content item 220 and an indication of the social network group. The data provided for display may be transmitted to the client computing device 130. After step 690, the process 600 ends.

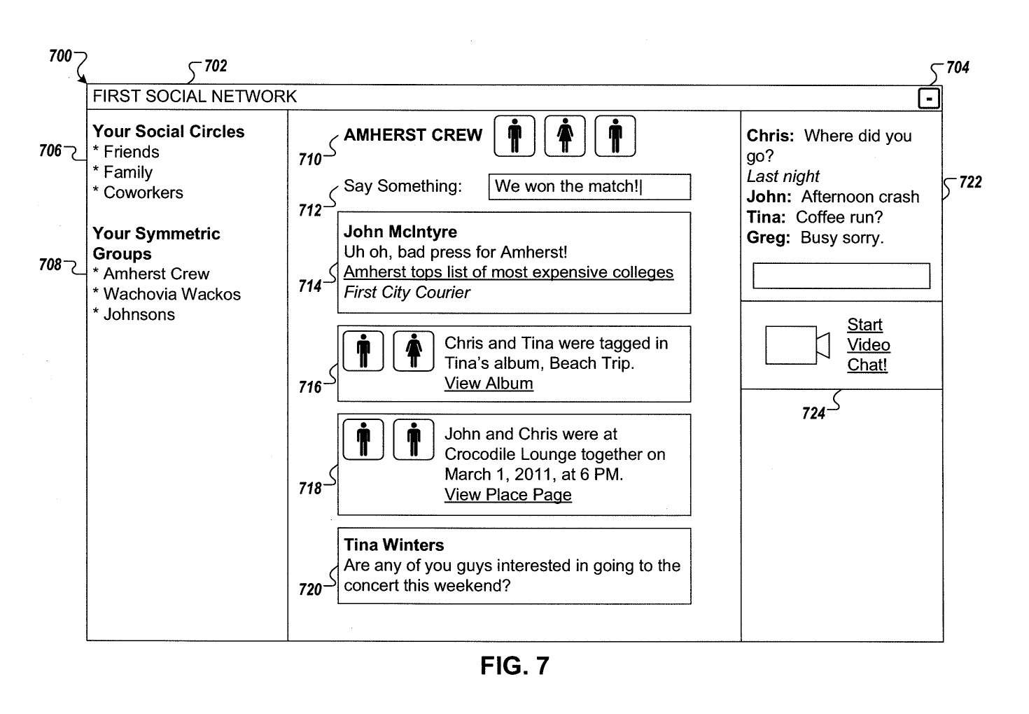

FIG. 7 illustrates an example web browser window 700 configured to display content items related to a social network group.

As shown, the web browser window 700 includes a title bar 702, a close button 704, lists of social network groups 706 and 708, an indication of the social network group 710 that is being displayed, and content items 712, 714, 716, 718, 720, 722, and 724 related to the social network group being displayed.

The title bar 702 may display a title of the web page being displayed or the name of a provider of the web page, for example, “First Social Network.” The close button 704, when clicked, is configured to cause the web browser window 700 to be closed. The list of social circles 706 may include one or more social circles associated with a user of the web browser window who may be logged into a social networking service. For example, the user may have social circles titled “Friends,” “Family,” and “Coworkers.” The list of symmetric groups 708 may include one or more symmetric social network groups of which the user is a member. As illustrated, the symmetric social network groups include “Amherst Crew,” “Wachovia Wackos,” and “Johnsons.”

The indication of the social network group 710 indicates that information about the social network group is being displayed in the web browser window 700. The indication of the social network group 710 may include a name of the social network group or one or more photographs associated with the social network group. In one example, the indication of the social network group 710 may include photographs of one or more members of the social network group. An input box 712 may be provided to allow the user to enter information to be associated with the social network group. Various content items 714, 716, 718, and 720 that are associated with the social network group may be displayed in a feed associated with the social network group in the web browser window 700. For example, a subject member of the social network group may have posted an article 714 related to the social network group. An object associated with photo album 716 including two or more subject members of the social network group may also be displayed. Information indicating that two or more members of a social network group were at the same geographic location 718 may also be displayed. Comments 720 posted by subject members of the group may also be displayed.

Some of the content items 714, 716, 718, or 720 may have been posted to the social network group via input box 712 in the social network group. Alternatively, some of the content items may have been automatically added to the social network group based on content posted by the subject members to other feeds, for example, via the processes 500 and 600 described in conjunction with FIGS. 5-6. The content of a chat session 722 including subject members of the social network group may be displayed. However, one or more of the participants in the chat session may opt out of having his/her chat sessions displayed to the viewing members of the social network group in association with the social network group. In addition, a button or link to start a video chat session 724 with one or more members of the social network group may be provided.

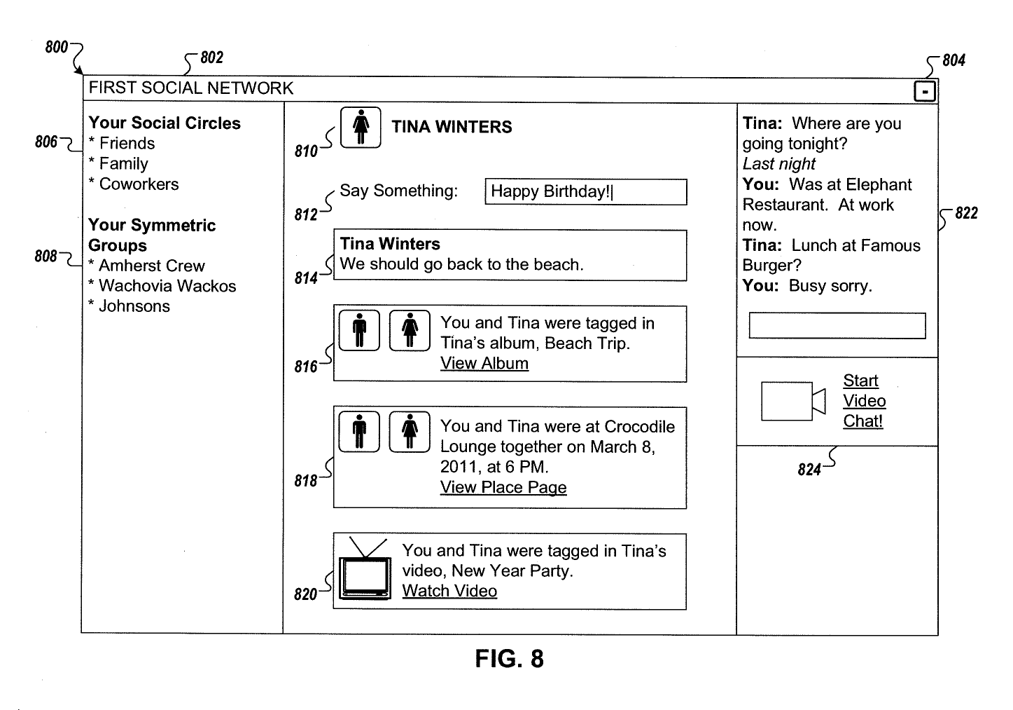

FIG. 8 illustrates an example web browser window 800 configured to display content items related to an individual profile.

As shown, the web browser window 800 includes a title bar 802, a close button 804, lists of social network groups 806 and 808, an indication of the individual profile 810 that is being displayed, and content items 812, 814, 816, 818, 820, 822, and 824 related to the individual profile being displayed.

The title bar 802 may display a title of the web page being displayed or the name of a provider of the web page, for example, “First Social Network.” The close button 804, when clicked, is configured to cause the web browser window 800 to be closed. The list of social circles 806 may include one or more social circles associated with a user of the web browser window who may be logged into a social networking service. For example, the user may have social circles titled “Friends,” “Family,” and “Coworkers.” The list of symmetric groups 808 may include one or more symmetric social network groups of which the user is a member. As illustrated, the symmetric social network groups include “Amherst Crew,” “Wachovia Wackos,” and “Johnsons.”

The indication of the individual profile 810 indicates that information about the individual profile is being displayed in the web browser window 800. The indication of the social network group 810 may include a name of a person associated with the individual profile or one or more photographs of the person. In one example, the indication of the individual profile 810 may include a photograph provided by the person associated with the individual profile, which may or may not include the person. An input box 812 may be provided to allow the user to enter information to be posted in a feed associated with the individual profile being displayed. Various content items 814, 816, 818, and 820 that are associated with the individual profile may be displayed in the web browser window 800. The person associated with the individual profile may have posted a comment 814, a photograph album 816, or a video 820. One or more of these content items (e.g., content items 816 and 820) may include the user, for example if a member of the social networking service indicated that the user was included in a photograph or video or if the user was named in a content item.

One or more content items (e.g., content item 818) may indicate togetherness of the user and the person associated with the individual profile being displayed. For example, both the user and the person associated with the individual profile being displayed may have been at the same location at approximately the same time. Content item 818 may have been derived based on separate geographic check-ins by the user and the person associated with the individual profile, for example, via the process 600 described above in conjunction with FIG. 6. The content of a chat session 822 between the user and the person associated with the individual profile may be displayed. In addition, a button or link to start a video chat session 824 with the person associated with the individual profile may be provided.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technologies described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

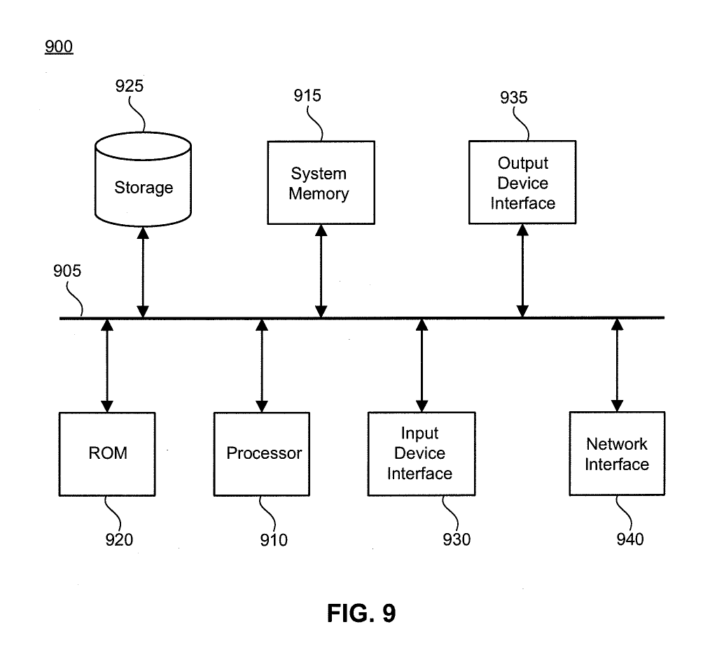

FIG. 9 conceptually illustrates an electronic system 700 with which some implementations of the subject technology are implemented. For example, one or more of the database 110, the content presentation server 120, or the client computing device 130 may be implemented using the arrangement of the electronic system 700. The electronic system 700 can be a computer, phone, PDA, or any other sort of electronic device. Such an electronic system includes various types of computer readable media and interfaces for various other types of computer readable media. Electronic system 700 includes a bus 905, processing unit(s) 910, a system memory 915, a read-only memory 920, a permanent storage device 925, an input device interface 930, an output device interface 935, and a network interface 940.

The bus 905 collectively represents all system, peripheral, and chipset buses that communicatively connect the numerous internal devices of the electronic system 700. For instance, the bus 905 communicatively connects the processing unit(s) 910 with the read-only memory 920, the system memory 915, and the permanent storage device 925.

From these various memory units, the processing unit(s) 910 retrieves instructions to execute and data to process in order to execute the processes of the subject technology. The processing unit(s) can be a single processor or a multi-core processor in different implementations.

The read-only-memory (ROM) 920 stores static data and instructions that are needed by the processing unit(s) 910 and other modules of the electronic system. The permanent storage device 925, on the other hand, is a read-and-write memory device. This device is a non-volatile memory unit that stores instructions and data even when the electronic system 700 is off. Some implementations of the subject technology use a mass-storage device (such as a magnetic or optical disk and its corresponding disk drive) as the permanent storage device 925.

Other implementations use a removable storage device (such as a floppy disk, flash drive, and its corresponding disk drive) as the permanent storage device 925. Like the permanent storage device 925, the system memory 915 is a read-and-write memory device. However, unlike storage device 925, the system memory 915 is a volatile read-and-write memory, such a random access memory. The system memory 915 stores some of the instructions and data that the processor needs at runtime. In some implementations, the processes of the subject technology are stored in the system memory 915, the permanent storage device 925, and/or the read-only memory 920. For example, the various memory units include instructions for displaying content items related to a social network group, in accordance with some implementations. From these various memory units, the processing unit(s) 910 retrieves instructions to execute and data to process in order to execute the processes of some implementations.

The bus 905 also connects to the input and output device interfaces 930 and 935. The input device interface 930 enables the user to communicate information and select commands to the electronic system. Input devices used with input device interface 930 include, for example, alphanumeric keyboards and pointing devices (also called “cursor control devices”). Output device interfaces 935 enables, for example, the display of images generated by the electronic system 700. Output devices used with output device interface 935 include, for example, printers and display devices, such as cathode ray tubes (CRT) or liquid crystal displays (LCD). Some implementations include devices such as a touchscreen that functions as both input and output devices.

Finally, as shown in FIG. 9, bus 905 also couples electronic system 700 to a network (not shown) through a network interface 940. In this manner, the electronic system 700 can be a part of a network of computers (such as a local area network (“LAN”), a wide area network (“WAN”), or an Intranet, or a network of networks, such as the Internet. Any or all components of electronic system 700 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method comprising:
creating, at one or more computing devices, a new content item, wherein the new content item comprises an indication of togetherness of two or more subject members in a set of subject members of a social network group and is determined from content generated by the two or more subject members, wherein the new content item is not initially associated with the social network group comprising the set of subject members and a set of viewing members, and wherein the set of subject members comprises one or more users having permission to post content for the social network group;
determining, at the one or more computing devices, that the new content item is related to the social network group;
storing, in a memory associated with the one or more computing devices, the new content item in association with the social network group; and
providing for display a representation of the new content item and an indication of the social network group.

2. The method of claim 1, wherein the indication of the social network group comprises a name associated with the social network group or an image associated with the social network group.

3. The method of claim 1, wherein the new content item includes one or more of a photograph, a video, a geographic check-in, a current location of a mobile device, a review of a point of interest, a calendar event, or a text, audio or video chat room interface.

4. The method of claim 1, wherein the social network group comprises one or more of: a group of users in a computer or mobile phone-based chat session, a social circle, an individual profile in a social networking service or a combination of two individual profiles in the social networking service.

5. The method of claim 1, wherein determining that the new content item is related to the social network group comprises determining that the new content item is associated with at least two subject members of the social network group.

6. The method of claim 1, wherein creating the new content item comprises:
receiving a first content item that is not associated with the social network group, wherein the first content item is associated with a set of members having permission to view the first content item;
receiving a second content item that is not associated with the social network group, wherein the second content item is associated with a set of members having permission to view the first content item;
determining that the first content item is related to the second content item; and
automatically creating the new content item based on the first content item and the second content item.

7. The method of claim 6, wherein determining that the first content item is related to the second content item comprises determining that the first content item and the second content item are associated with a same geographic point of interest.

8. The method of claim 7, wherein determining that the first content item is related to the second content item further comprises determining that a time difference between a time associated with the first content item and a time associated with the second content item is less than a time difference threshold.

9. The method of claim 6, further comprising:
determining that the first content item is associated with a first individual profile, wherein the first individual profile is associated with a first subject member in the set of subject members of the social network group;
determining that the second content item is associated with a second individual profile, wherein the second individual profile is associated with a second subject member in the set of subject members of the social network group; and
determining that, within a time period, a number of interactions between the first individual profile and the second individual profile is less than an interaction-per-unit-time threshold.

10. The method of claim 6, further comprising:
receiving the set of members who have permission to view the first content item that is not associated with the social network group;
receiving the set of members who have permission to view the second content item that is not associated with the social network group; and
determining a set of members who have permission to view the new content item based on an intersection of the set of members who have permission to view the first content item and the set of members who have permission to view the second content item.

11. The method of claim 1, further comprising:
determining that all of the viewing members of the social network group have permission to view the new content item; and
storing the new content item in association with the social network group based on the determination that all of the viewing members of the social network group have permission to view the new content item.

12. A non-transitory computer-readable medium comprising instructions that, when executed by a computer, cause the computer to:
create a new content item, wherein the new content item comprises an indication of togetherness of two or more subject members in a set of subject members of a social network group and is determined from content generated by the two or more subject members, wherein the new content item is not initially associated with a social network group comprising a set of subject members and a set of viewing members, and wherein the set of subject members comprises one or more users having permission to post content for the social network group;
determine that the new content item is related to the social network group;
store the new content item in association with the social network group; and
transmit for display a representation of the new content item to a feed associated with the social network group.

13. The non-transitory computer-readable medium of claim 12, wherein the set of viewing members of the social network group comprises the set of subject members of the social network group.

14. The non-transitory computer-readable medium of claim 13, wherein the set of viewing members of the social network group is identical to the set of subject members of the social network group.

15. The non-transitory computer-readable medium of claim 12, wherein at least one subject member of the social network group is not a viewing member of the social network group.

16. The non-transitory computer-readable medium of claim 12, wherein the instructions to create the new content item comprise instructions that, when executed by the computer, cause the computer to:
receive a first content item that is not associated with the social network group;
receive a second content item that is not associated with the social network group;
determine that the first content item is related to the second content item;
automatically create the new content item based on the first content item and the second content item.

17. The non-transitory computer-readable medium of claim 16, further comprising instructions that, when executed by the computer, cause the computer to:
determine that the first content item is associated with a first individual profile, wherein the first individual profile is associated with a first subject member in the set of subject members of the social network group;
determine that the second content item is associated with a second individual profile, wherein the second individual profile is associated with a second subject member in the set of subject members of the social network group; and
determine that, within a time period, a number of interactions between the first individual profile and the second individual profile is less than an interaction-per-unit-time threshold.

18. The non-transitory computer-readable medium of claim 12, wherein the instructions to determine that the new content item is related to the social network group comprise instructions that, when executed by the computer, cause the computer to:
determine that the new content item is associated with at least a certain proportion of the subject members of the social network group.

19. The non-transitory computer-readable medium of claim 12, further comprising instructions that, when executed by a computer, cause the computer to:
receive a request to view the social network group comprising the set of subject members and the set of viewing members from a requestor;
determine that the requestor is a viewing member of the social network group; and
determine that the requestor has permission to view the new content item.

20. A system comprising:
one or more processors; and
a memory comprising instructions that, when executed by the one or more processors, cause the one or more processors to:
create a new content item, wherein the new content item comprises an indication of togetherness of two or more subject members in a set of subject members of a social network group and is determined from content generated by the two or more subject members, wherein the new content item is not initially associated with a social network group;
determine that the new content item is related to the social network group;
store the new content item in association with the social network group; and
provide for display a representation of the new content item and an indication of the social network group to a feed associated with the social network group, wherein the indication of the social network group comprises a name associated with the social network group or an image associated with the social network group.
